(19) United States
(12) Patent Application Publication
(10) Pub. No.: US 2023/0354086 A1
(43) Pub. Date: Nov. 2, 2023

(54) USE OF DEEP PACKET INSPECTION WITH WI-FI QoS MANAGEMENT

(71) Applicant: ARRIS Enterprises LLC, Suwanee, GA (US)

(72) Inventors: Jay W. STRATER, San Diego, CA (US); Gregory N. NAKANISHI, San Diego, CA (US); Paul D. BAKER, San Diego, CA (US); Rajagopalan RAMANUJAM, San Jose, CA (US)

(21) Appl. No.: 18/127,812

(22) Filed: Mar. 29, 2023

Related U.S. Application Data
(60) Provisional application No. 63/336,736, filed on Apr. 29, 2022.

(51) Int. Cl. H04W 28/02

(52) U.S. Cl. CPC H04W 28/0268

(57) ABSTRACT

An access point device can utilize a deep packet inspection (DPI) management device for inspecting traffic associated with a session of a station for quality of service (QoS) information. The QoS information is compared to DPI application and device categories. Based on the comparison a Wi-Fi QoS Management controller of the access point device can determine a QoS policy for the session based on the comparison. The access point device can send a request to the station to assign a QoS priority to the session based on the QoS policy. The request can apply to upstream traffic, downstream traffic, or both. The QoS policy provide a priority level for the session so that the associated traffic receives a QoS appropriate or required by the associated application, device, or both so as to provide Wi-Fi QoS Management for traffic associated with the station.

### BACKGROUND

Wireless Fidelity (Wi-Fi) Alliance (WFA) Wi-Fi quality of service (QoS) Management provides several way to manage QoS in a Wi-Fi network between access points and stations (such as client devices). For example, mirrored stream classification service (MSCS) enables station initiated negotiation of downlink QoS based on QoS mirroring, differentiated service code point (DSCP)-to-IEEE 802.11 user priority (UP) mapping assigns downlink and uplink QoS based on DSCP marking of internet protocol (IP) packets, either using a default mapping table, or using a specific mapping table configured using QoS map capability, stream classification service (SCS) enables a station initiated negotiation of downlink QoS based on explicit stream classifiers, and DSCP policy capability enables unsolicited and query-based configuration of uplink DSCP marking policies by access points on stations. The first two examples are initiated by a station, while the third example applies to a QoS mapping configuration assigned to a station and access point, and the fourth method is initiated by an access point.

For the fourth example, an access point is presumed to know what downstream QoS (for example, DSCP) to assign to certain traffic (for example, traffic sessions associated with specific applications) and to request a station make a similar upstream QoS assignment. The access point must know what type of traffic needs what QoS support. An application needing QoS for one or more associated traffic sessions and the associated QoS requirements for traffic associated with the application can be determined via a user assignment and can be remotely configured (for example, using a cloud management system). However in doing so, the user is burdened with individual application and application QoS determinations. Additionally, application assignment may also be restricted to tuple information (IP source/destination addresses, MAC source/destination addresses, and transport protocol type) which may not address all QoS traffic needs. Thus there is a need for improved Wi-Fi QoS Management that does not burden a user.

### SUMMARY

According to aspects of the present invention, an access point device with deep packet inspection (DPI) support (for example, a gateway device) can provide improved Wi-Fi QoS Management and upstream (US) wide area network (WAN) QoS without burdening a user with excessive configuration requirements. DPI allows for identification of traffic associated with an application as well as one or more device categories. The access point device can be remotely (or locally) configured with a DPI application and/or one or more device categories that need added QoS and the QoS assignments for these one or more device categories. The access point device can utilize DPI to detect traffic associated with a chosen or selected application and/or device category - this may occur within one or more packets at the start of an application and/or traffic session of a network device. The access point device can then assign the appropriate QoS whether downstream or upstream to the traffic depending on the chosen or selected application and/or one or more device categories. In this way, high priority traffic receives a sufficient QoS to support the needs of the corresponding application, device, or both.

An aspect of the present disclosure is drawn to an access point device to provide quality of service (QoS) prioritization using deep packet inspection (DPI). The access point device comprises a memory storing one or more computer-readable instructions, and a processor coupled to the memory. The processor is configured to execute the one or more computer-readable instructions to cause the access point device to receive one or more packets from a station, inspect the one or more packets for QoS information using DPI, compare the QoS information to one or more DPI application categories, one or more DPI device categories, or both, determine a QoS policy from one or more QoS policies based on the comparison, and assign the QoS policy to traffic associated with the session.

In an aspect of the present disclosure, the processor is further configured to execute the one or more computer-readable instructions to further cause the access point device to receive any of the one or more DPI application categories, the one or more DPI device categories, one or more QoS policies, or any combination thereof from a network resource.

In an aspect of the present disclosure, the QoS policy is a wireless fidelity (Wi-Fi) QoS Management differentiated services code point (DSCP) policy.

In an aspect of the present disclosure, the assigning the QoS policy to the traffic associated with the session comprises at least one of: send a request to the station to assign an upstream station QoS priority to upstream station traffic of a session associated with the one or more packets based on the QoS policy, assign a downstream station QoS priority to downstream station traffic, to the station, of the session associated with the one or more packets based on the QoS policy, and assign an upstream access point QoS priority to upstream access point traffic of the session associated with the one or more packets based on the QoS policy.

In an aspect of the present disclosure, the upstream station QoS priority provides a wireless fidelity multi-media (WMM) upstream station QoS prioritization

In an aspect of the present disclosure, the downstream station QoS priority provides a wireless fidelity multi-media (WMM) downstream QoS prioritization.

In an aspect of the present disclosure, the access point device is included in an EasyMesh network, and wherein the station is an extender access point device.

An aspect of the present disclosure is drawn to a method by an access point device to provide quality of service (QoS) prioritization using deep packet inspection (DPI). The method comprises receiving one or more packets from a station, inspecting the one or more packets for QoS information using DPI, comparing the QoS information to one or more DPI application categories, one or more DPI device categories, or both, determining a QoS policy from one or more QoS policies based on the comparison, and assigning the QoS policy to traffic associated with the session.

In an aspect of the present disclosure, the method further comprises receiving any of the one or more DPI application categories, the one or more DPI device categories, one or more QoS policies, or any combination thereof from a network resource.

In an aspect of the present disclosure, the method is such that the QoS policy is a wireless fidelity (Wi-Fi) QoS Management differentiated services code point (DSCP) policy.

In an aspect of the present disclosure, the method is such that the assigning the QoS policy to the traffic associated with the session comprises at least one of sending a request to the station to assign an upstream station QoS priority to upstream station traffic of a session associated with the one or more packets based on the QoS policy, assigning a downstream station QoS priority to downstream station traffic, to the station, of the session associated with the one or more packets based on the QoS policy, and assigning an upstream access point QoS priority to upstream access point traffic of the session associated with the one or more packets based on the QoS policy.

In an aspect of the present disclosure, the method is such that the upstream station QoS priority to provides a wireless fidelity multi-media (WMM) upstream QoS prioritization.

In an aspect of the present disclosure, the method is such that the downstream station QoS priority provides a wireless fidelity multi-media (WMM) downstream QoS prioritization

In an aspect of the present disclosure, the method is such that the access point device is included in an EasyMesh network, and wherein the station is an extender access point device.

An aspect of the present disclosure provides a non-transitory computer readable medium of an access point device having one or more computer-readable instructions stored thereon. The one or more computer-readable instructions when executed by a processor of the access point device, cause the access point device to perform one or more operations including the steps of the methods described herein.

### BRIEF DESCRIPTION OF THE DRAWINGS

FIG. 1A is a diagram of a network environment for providing improved Wi-Fi QoS Management, according to one or more aspects of the present disclosure;

FIG. 1B is a diagram of a network environment for providing improved Wi-Fi QoS Management, according to one or more aspects of the present disclosure;

FIG. 2 is a block diagram of a hardware configuration for one or more network devices, according to one or more aspects of the present disclosure;

FIG. 3 is a flow diagram for an access point device to use DPI to provide Wi-Fi QoS Management, according to one or more aspects of the present disclosure;

FIG. 4 is a block diagram illustrating using DPI to provide Wi-Fi QoS Management, according to one or more aspects of the present disclosure;

FIG. 5 is a flow diagram for an access point device to use DPI to provide Wi-Fi QoS Management, according to one or more aspects of the present disclosure; and

FIG. 6 is a flowchart for a method of using DPI to provide Wi-Fi QoS Management, according to one or more aspects of the present disclosure.

Like reference numbers and designations in the various drawings indicate like elements.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded as merely examples and not for the purpose of limiting the present disclosure as defined by the appended claims and their equivalents. The words and phrases used in the following description and claims are merely used to enable a clear and consistent understanding of the present disclosure. In addition, descriptions of well-known structures, functions, and configurations may be omitted for clarity and conciseness. Those of ordinary skill in the art will recognize that various changes and modifications of the examples described herein can be made without departing from the spirit and scope of the present disclosure.

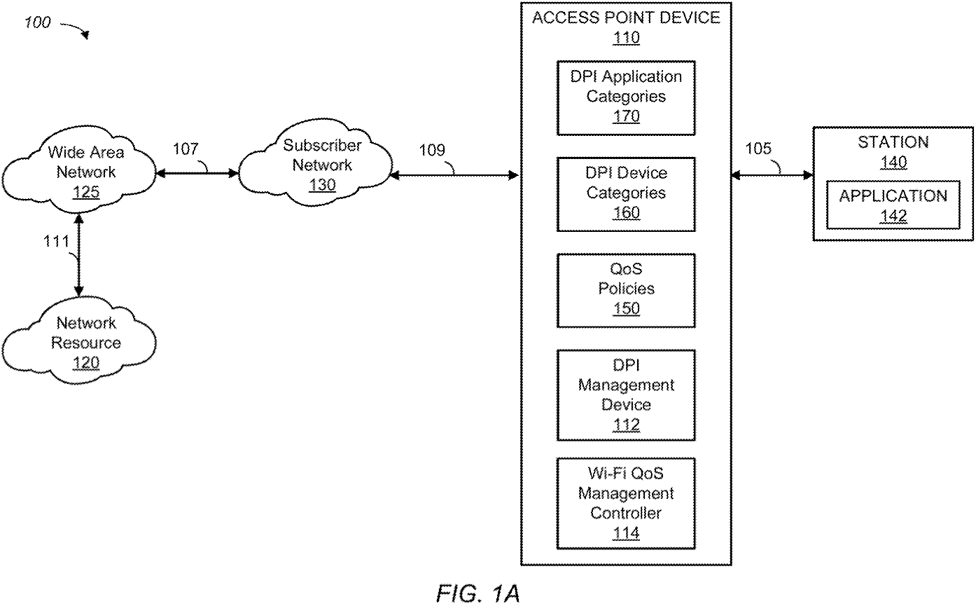

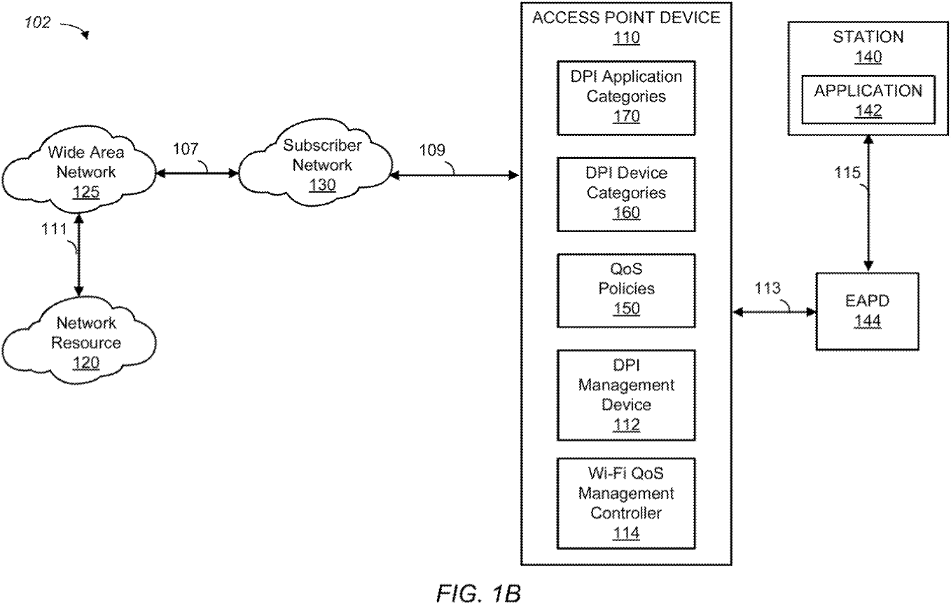

FIG. 1A is a diagram of a network environment 100 for providing improved Wi-Fi QoS management, according to one or more aspects of the present disclosure. The network environment 100 comprises one or more network devices so as to form a network, such as any of one or more electronic devices 140 (such as any of a client device, a station (STA), an extender access point device (EAPD), any other device capable of connecting to an access point device, or any combination thereof), an access point device (APD) 110, a subscriber network 130, a wide area network 125 (WAN), and a network resource 120. While FIG. 1 illustrates various devices, the present disclosure contemplates any number of devices within the access network environment 100.

In one or more embodiments, a station 140 (or wireless device) can be any type of a device that connects to an access point device 110 and is capable of or configured to send and/or receive one or more packets (also referred to generally as traffic), for example, any of a handheld computing device, a personal computer (such as a desktop, laptop, etc.), an electronic tablet, a mobile phone, a smart phone, an Internet-of-Things (IoT) device (such as smart assistant, iControl devices, portable music players with smart capabilities capable of connecting to the Internet, cellular networks, and interconnecting with other devices via Wi-Fi and Bluetooth (BT)), any other wireless electronic device, or any combination thereof. An electronic device 140 can be connected to an access point device 110 via a connection 105.

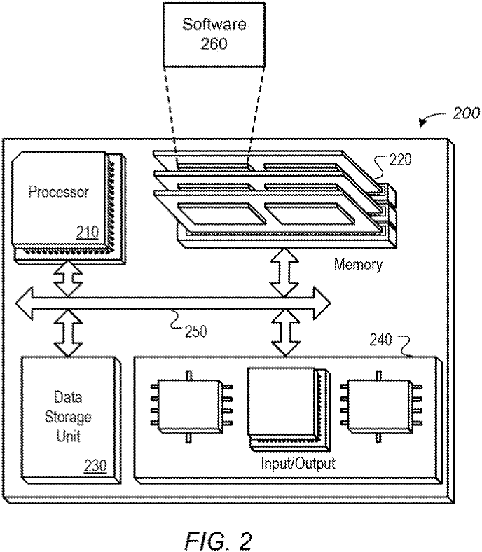

The access point device 110 can be an electronic device that supports DPI for use with providing Wi-Fi QoS Management. The access point device 110 can comprise an access point and/or a hardware electronic device that can be a combination modem and gateway that combines the functions of a modem (for example, a cable modem, DSL modem, passive optical network (PON) optical network terminal (ONT), and/or Fixed Wireless Access 5G modem), an access point (AP), and/or a router for providing content, data or information received from one or more stations 140 to a subscriber network 130. An access point device 110 can be referred to as a residential gateway, a home network gateway, or a wireless access point. The access point device 110 can comprise a DPI management device 112, a Wi-Fi QoS Management controller, and information associated with DPI and/or Wi-Fi QoS Management (for example, any of one or more DPI application categories 170, one or more DPI device categories 160, and one or more QoS policies 150, or any combination thereof) stored in a memory 200 as discussed with reference to FIG. 2.

The DPI management device 112 can comprise hardware, software, or both for performing DPI of one or more packets, such as traffic, received by the access point device 110, for example, the DPI management device 112 can be any of an engine, a controller, any other software, any other hardware, or any combination thereof. The DPI management device 112 can inspect one or more packets received from a station 140, a subscriber network 130, or both and detect traffic associated with one or more application categories 170,one or more device categories 160, or both so as to identify an application, a station 140 or both for QoS management.

The Wi-Fi QoS Management controller 114 can comprise hardware, software, or both for managing the QoS of traffic received by the access point device 110. For example, the Wi-Fi QoS Management controller 114 can assign an appropriate QoS whether downstream or upstream to the traffic inspected by the DPI management device 112 and identified as associated with an application 142, a station 140, or both depending on a QoS policy 150 associated with or that corresponds to the identified application 142, the identified station 140, or both. In this way, high priority traffic receives a sufficient QoS to support the needs of the identified application, the identified station 140, or both based on an associated QoS policy 150.

The DPI application categories 170 can comprise any of a gaming application, a video streaming application, a security or monitoring application, a storage system application, a video conference application, any other application associated with an electronic device 140, or any combination thereof. For example, an application 142 can be associated with one or more DPI application categories 170. Each of the one or more DPI device categories 160 can be associated with at least one of the one or more QoS policies 150. The one or more DPI device categories 160 can comprise any of a gaming system, a video streaming system, a video conference system, a smart television, a set-top box, a security alarm or detection system, an electronic storage system, any other type of system and/or device that connects to the network 100 and/or the access point device 110, or any combination thereof. For example, a station 140 can be associated with one or more DPI device categories 160. Each of the one or more DPI device categories 160 can be associated with at least one of the one or more QoS policies 150. The one or more QoS policies 150 can comprise information to facilitate classification of one or more packets, such as any of a DSCP value, a priority value, any other prioritization information, or any combination thereof so as to indicate a priority for QoS. A QoS policy can indicate any of an upstream QoS priority for upstream station traffic (a QoS priority for traffic from the station 140 to the access point device 110), downstream station QoS priority for downstream station traffic (a QoS priority for traffic from the access point device 110 to the station 140), an upstream access point QoS priority for upstream access point traffic (a QoS priority for traffic from the access point device 110 to the network, such as to any of a subscriber network 130, a WAN 125, a network resource 120, or any combination thereof), or any combination thereof. For example, a QoS policy 150 can comprise a DSCP value that indicates a DSCP to application category assignment (for a subset of application categories that need high prioritization). As an example, gaming can be an application category and a gaming application with expedited forwarding (EF) can be assigned a DSCP of 46 and video streaming with real-time interactive (CS4) can be assigned a DSCP of 32 for a given session where DPI detected the respective application category. The session identification resulting from the DPI can be a tuple of source/destination IP address, source/destination port, and protocol, a source port, or destination port. The QoS policy 150 can comprise an IEEE 802.1Q (Dot 1Q) priority code point (PCP) (p-bit) to application category assignment. For example, p-bit values of 5 and 4 could be added for PON WAN egress traffic. Similarly, a QoS policy 150 can apply to a device category needing prioritization.

A subscriber network 130 can be communicatively coupled to the access point device 110 via a connection 109. For example, the access point device 110 can route to the subscriber network 130 one or more packets (or traffic) assigned a QoS based on an associated QoS policy 150 as determined by the Wi-Fi QoS Management controller 114 based on DPI performed by the DPI management device 112. The subscriber network 130 can, for example, be located at a head end of a multiple system operator (MSO). The subscriber network 130 can connect the access point device 110 to a network resource 120 via a connection 107 between the subscriber network 130 and a WAN 125 and via a connection 11 between the WAN 125 and the network resource 120. The network resource can configure the access point device for using DPI, for example, by providing and/or updating one or more DPI application categories 170, one or more DPI device categories 160, one or more QoS policies 150.

FIG. 1B is a diagram of a network environment 102 for providing improved Wi-Fi QoS management, according to one or more aspects of the present disclosure. FIG. 1B is similar to or the same as FIG. 1A, except the station 140 is connected to the access point device 110 via connection 115 to an extender access point device 144 that is connected via a connection 113 to the access point device 110. The extender access point device 144 can be, for example, wireless hardware electronic devices such as access points, extenders, repeaters, etc. used to extend the wireless network by receiving the signals transmitted by the access point device 110 and rebroadcasting the signals to, for example, one or more stations 140 which may be out of range of the access point device 2. The extender access point device 144 can also receive signals from the one or more stations 140 and rebroadcast the signals to the access point device 110, or one or more other stations 140. In FIG. 1B, the access point device 110 supports at least EasyMesh release 4 or later. The access point device 110 can comprise an EasyMesh controller, for example, as part of or separate from a processor 210 discussed with reference to FIG. 2, can set a QoS policy 150 for the station 140 at an access point multi-access point agent (MAPA) (that is within the access point device 110, the extender access point device 144, or both) in the network 100 after receiving a tunneled DSCP policy query from the station 140 at the access point device 110.

FIG. 2 is a block diagram of a hardware configuration 200 for one or more network devices within a network environment 100, for example, any of an electronic device 140, an access point device 110, an extender access point device 144, or any combination thereof. The hardware configuration 200 can comprise a processor 210, a memory 220, a storage device or data storage unit 230, and an input/output (I/O) device 240. Each of the components 210, 220, 230, and 240 can, for example, be interconnected using a system bus 250. The processor 210 can be capable of processing one or more computer-readable instructions for execution within the hardware configuration 200. In one or more embodiments, the processor 210 can be a single-threaded processor. In one or more embodiments, the processor 210 can be a multi-threaded processor. The processor 210 can be capable of processing one or more computer-readable instructions stored in the memory 220 and/or on the data storage unit or storage device 230. In one or more embodiments, any of the one or more DPI application categories 170, the one or more DPI device categories 160, the one or more QoS policies 150, or any combination thereof are stored in the data storage unit 230.

The memory 220 can store information within the hardware configuration 200, such as any of the one or more DPI application categories 170, the one or more DPI device categories 160, the one or more QoS policies 150, or any combination thereof are stored in the data storage unit 230. In one implementation, the memory 220 can be a non-transitory computer-readable medium that stores one or more computer-readable instructions, such as software 260, that when executed by a processor 210 cause the network device to perform one or more operations according to one or more aspects of the present disclosure. For example, the Wi-Fi QoS Management controller 114, the DPI management device 112, or both can comprise any of a processor 210, a memory 220, a software 260, any other hardware element, any other one or more computer-readable instructions, or any combination thereof. In one implementation, the memory 220 can be a volatile memory unit. In another implementation, the memory 220 can be a non-volatile memory unit. In one or more embodiments, the storage device 230 can be capable of providing mass storage for the hardware configuration 200. In one implementation, the data storage unit 230 can be a non-transitory computer-readable medium. In various different implementations, the data storage unit 230 can, for example, include a hard disk device, an optical disk device, flash memory or some other large capacity storage device. In other implementations, the data storage unit 230 can be a device external to the hardware configuration 200.

The I/O device 240 provides I/O operations for the hardware configuration 200. In one implementation, the I/O device 240 can include one or more of a network interface device (for example, an Ethernet card), a serial communication device (for example, an RS-232 port), one or more universal serial bus (USB) interfaces (for example, a USB 2.0 port), one or more wireless interface devices (for example, an 802.11 card) for outputting video, voice, and/or data services to a station 140 of FIG. 1 (for example, television, STB, computer, mobile device, tablet, telephone, wearable, etc.). As an example, the I/O device 240 can include one or more driver devices configured to send communications to, and receive communications from one or more networks and/or one or more network devices.

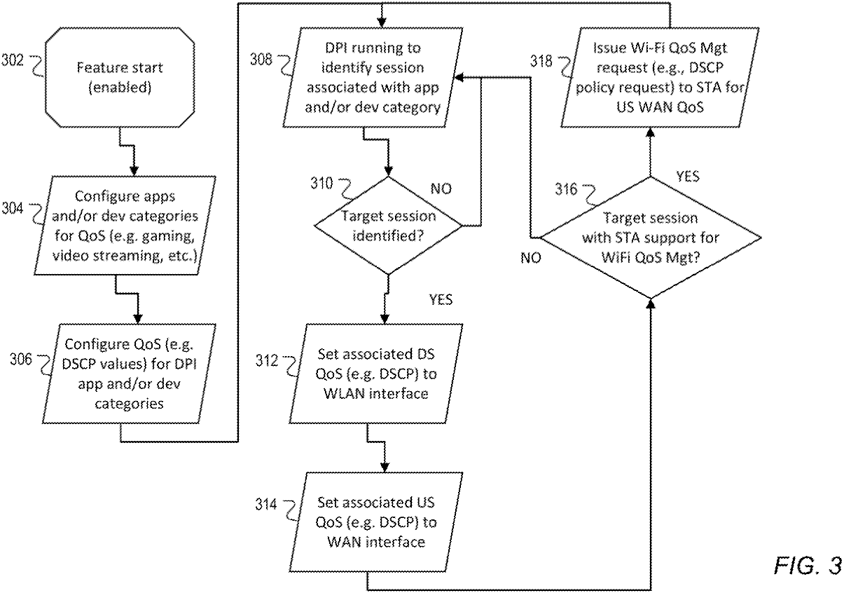

FIG. 3 is a flow diagram for an access point device 110 to use DPI to provide Wi-Fi QoS Management, according to one or more aspects of the present disclosure. In one or more embodiments, a network device, for example, an access point device 110, supports DPI. While an access point device 110 is referred to as performing the process of FIG. 3, the present disclosure contemplates that the steps of FIG. 3 can be performed by any network device that supports Wi-Fi QoS Management using DPI as discussed herein.

At 302, the access point device 110 determines that DPI is supported. At 304, DPI management device 112 of the access point device 110, receives configuration information from a user or an operator service, for example, as provided by any of the subscriber network 130, the network resource 120, a user interface (such as any of a web portal, a command line interface (CLI), any other user interface, or any combination thereof), or any combination thereof. The configuration information is used by the DPI management device 112 to configure any of one or more DPI application (app) categories 170, one or more DPI device (dev) categories 160, or any combination thereof. At 306, the Wi-Fi QoS Management controller 114 configures the one or more QoS policies 150 based on the configuration information. For example, any or each of the one or more DPI device categories 160, the one or more DPI application categories 170, or both can be associated with a QoS policy 150. In one or more embodiments, a default configuration can be used for the one or more DPI device categories 160, the one or more DPI application categories 170, and the associated one or more QoS policies 150. In one or more embodiments, processor 210 can execute one or more computer-readable instructions stored in a memory 220 to configure any of the one or more DPI application categories 170, the one or more DPI device categories 160, the one or more QoS policies 150, or any combination thereof.

At 308, the DPI management device 112 runs DPI to identify a session associated with a DPI application category 170, a DPI device category 160, or both. For example, the access point device 110 can receive one or more packets associated with a session of the station 140. The DPI management device 112 can parse from or otherwise inspect the one or more packets (such as an IP header) for information associated with a QoS priority and compare the information (for example, a signature) to a DPI device category 160, a DPI application category 170, or both. If the comparison results in a match (for example, the information matches or corresponds to a DPI device category 160, a DPI application category 170, or both), the session is identified as a target session. At 310, the DPI management device 112 determines if a target session was identified. If a target session was not identified, then the process continues to 308. If a target session is identified, the process continues to step 312.

At 312, the Wi-Fi QoS Management controller 114 sets an associated downstream (DS) QoS, for example, a DSCP, for the target session identified in step 310, for example, a downstream session to wireless local area network (WLAN) interface. Setting a DS QoS for a target session associated with a high priority DPI application category 170, a DPI device category 160, or both results in an appropriate Wi-Fi multi-media (WMM) QoS prioritization. At 314, the Wi-Fi QoS Management controller 114 sets an associated upstream (US) QoS, for example, a DSCP, for the target session identified in step 310, for example, an upstream session to WAN interface.

At 316, the Wi-Fi QoS Management controller 114 determines if the station 140 associated with the target session supports Wi-Fi QoS Management. If not supported, the process continues to 308. If supported, the process continues to 318. At 318, the Wi-Fi QoS Management controller 114 issues a Wi-Fi QoS Management (Mgt) request, for example, a DSCP policy request, to a station 140 for an upstream WAN QoS.

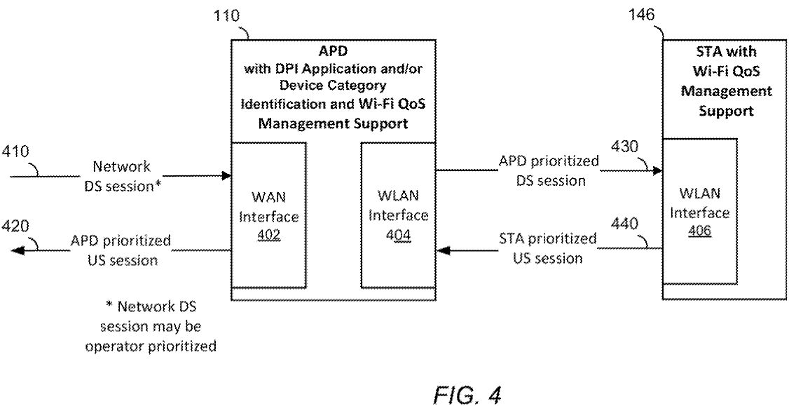

FIG. 4 is a block diagram illustrating using DPI to provide Wi-Fi QoS Management, according to one or more aspects of the present disclosure. An access point device 110 can comprise a WAN interface 402 that interfaces with, for example, a subscriber service 130 and/or a network resource 120 connected to a WAN 125, and a WLAN interface 404 that interfaces with, for example, a WLAN interface 406 of a station 140 (or any other network device as discussed with reference to FIG. 1). The access point device 110 supports identification of a DPI application category 160, a DPI device category 170, or both and includes Wi-Fi QoS Management support such that DPI is utilized to inspect one or more packets so as to identify a target session for assigning an associated QoS policy.

The WAN interface 402 of the access point device 110 receives a network DS session 410. The network DS session 410 can be prioritized by an operator. The access point device 110 can determine that a session is associated with a QoS policy 150 based on DPI of one or more packets associated with the session, for example, information associated with the one or more packets match a DPI device category 160 and/or a DPI application category 170, such that the session is identified as a target session. Traffic or packets associated with a DS session 430 are prioritized for sending to the WLAN interface 406 by the access point device 110 based on the QoS policy 150 associated with the target session. The station 140 can also be configured by the access point device 110 to prioritize an US session 440 associated with the target session for sending associated traffic or packets from the WLAN interface 406 to the WLAN interface 404. Similarly, the access point device 110 can prioritize an US session 420 for sending traffic or packets associated with the target session to a WLAN 125.

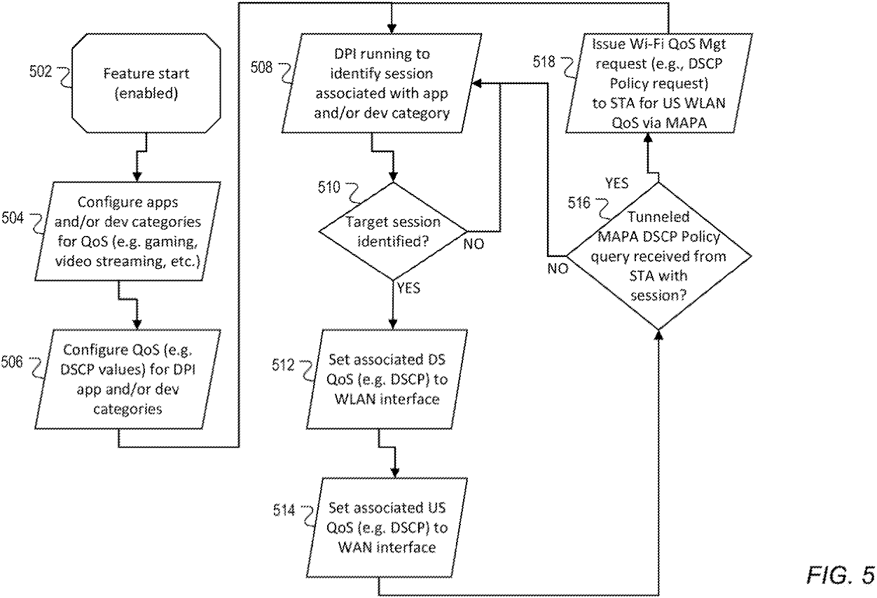

FIG. 5 is a flow diagram for an access point device 110 to use DPI to provide Wi-Fi QoS Management, according to one or more aspects of the present disclosure. FIG. 5 is similar to FIG. 3 except FIG. 5 is directed to an EasyMesh network environment. For example, when an access point device 110 is within a network environment 102 as discussed with reference to FIG. 2, the access point device 110 can leverage EasyMesh R4 or later to implement Wi-Fi QoS Management across the entire network environment 102, assuming EasyMesh MAP agents (MAPAs) within the access point device 110 and the one or more extender access point devices 144 support EasyMesh R4 or later. At 502, the process begins similar to or the same as 302 of FIG. 3. Similarly 504, 506, 508, 510, 512 and 514 are similar to or the same as 304, 306, 08, 310, 312 and 314, respectively. At 516, the access point device determines if a tunneled MAPA DSCP Policy query has been received from a station 140 with a session that is identified as requiring a high priority QoS. If not, the process continues at 508. If so, at 518, the access point device 110 issues a Wi-Fi QoS Management request, for example, a DSCP Policy request, to a station 140 for an US WLAN QoS via MAPA. For example, An EasyMesh R4 MAP controller (MAPC) can issue an appropriate Wi-Fi QoS Management DSCP Policy request for a station 140 that connects to a basic service set (BSS) in the network environment 102 (for example, on the access point device 110 or the extender access point device 144) and issues a DSCP Policy query to the BSS after step 516 for those sessions that have been identified as requiring high priority or enhanced QoS.

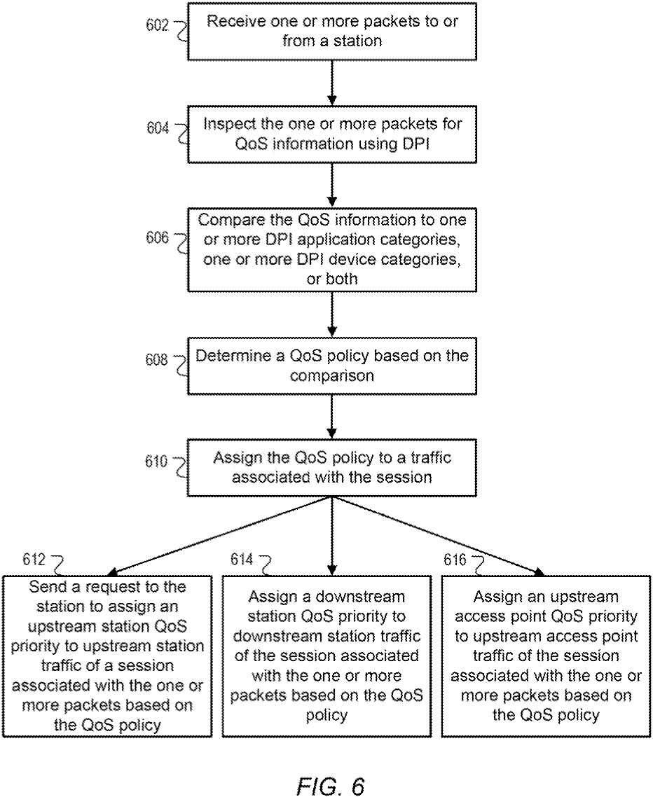

FIG. 6 is a flowchart for a method of using DPI to provide Wi-Fi QoS Management, according to one or more aspects of the present disclosure. In FIG. 6, it is assumed that any one or more network devices, such as an access point device 110, an extender access point device 144, and a station 140, include their respective controllers and/or processors and their respective software (such as one or more computer-readable instructions) stored in their respective memories, as discussed above in reference to FIGS. 1-5, which when executed by their respective controllers perform one or more functions or operations in accordance with the example embodiments of the present disclosure.

The processor 210 executes one or more computer-readable instructions, stored in a non-transitory computer-readable memory, for example, a memory 220 of an access point device 110, that when executed by the processor 210 perform and/or cause the access point device 110 to perform one or more of the operations of steps 602-616. In one or more embodiments, the one or more computer-readable instructions may be one or more software applications. While the steps 602-616 are presented in a certain order, the present disclosure contemplates that any one or more steps can be performed simultaneously, substantially simultaneously, repeatedly, in any order or not at all (omitted).

Prior or during operation or functioning of the access point device 110 to perform any of the steps 602-616, the access point device 110 can receive any of one of the one or more DPI application categories 170, the one or more DPI device categories 160, the one or more QoS policies 150, or any combination thereof, for example, from a network resource 120, a user, a subscriber network 130, or any combination thereof. In one or more embodiments, the access point device 110 is within an EasyMesh network, such as an EasyMesh R4 or later network, and the station is an extender access point device. At step 602, the access point device 110 receives one or more packets from a station 140. The one or more packets can be associated with a session and can require an enhanced QoS such that the one or more packets and any associated traffic (one or more other packets sent to and/or from the station 140) should be given a high priority as compared to other traffic.

At step 604, the access point device 110 inspects the one or more packets for QoS information using DPI. The QoS information can be any information that allows the access point device 110 to match the QoS information with a QoS policy 150, such as information indicative of an application (such as an application 142), a device (such as a station 140), or both.

At step 606, the access point device 110 compares the QoS information to one or more DPI application categories 170, one or more DPI device categories 160, or both. The comparison can provide or determine whether the QoS information matches or otherwise corresponds to any of the one or more DPI application categories 170, any of the one or more DPI device categories 160, or both.

At step 608, the access point device 110 determines a QoS policy 150 based on the comparison from step 606. For example, the access point device 110 can determine that the QoS information obtained from DPI of the one or more packets indicates that the one or more packets of a session are associated with an application, a device, or both that requires high priority based on a corresponding QoS policy 150. As an example, the access point device 110 can compare the QoS information to one or more of the DPI application categories 170. The comparison can indicate that the QoS information identifies a particular application that matches or corresponds to at least one of the DPI application categories 170. The access point device 110 can determine that the matched or corresponding DPI application category 170 is associated with a QoS policy 150. The QoS policy 150 can indicate a priority to be used for a traffic of the session directed to the particular application identified by the QoS information. In one or more embodiments, the QoS policy 150 is a Wi-Fi QoS Management DSCP policy.

At step 610, the access point device 110 can assign the QoS policy to a traffic associated with the session where the traffic is associated with a particular application, a particular device, or both as indicated by the comparison of step 606 based on the QoS information. Assigning the QoS policy in step 610 can comprise at least one of the steps 612, 614, and 616 such that any of steps 612, 614, 616, or any combination thereof can be performed by the access point device 110. In this way, a session (and the one or more packets or traffic associated with the session) is given an appropriate or required priority. For example, at step 612, the access point device 110 sends a request to the station 140 to assign an upstream station QoS priority to upstream station traffic of a session associated with the one or more packets based on the QoS policy. Similarly, at step 614, the access point device 110 assigns a downstream station QoS priority to downstream statin traffic of the session associated with the one or more packets based on the QoS policy. Similarly, at step 616, the access point device 110 assigns an upstream access point QoS priority to upstream access point traffic of the session associated with the one or more packets based on the QoS policy. In one or more embodiments, the upstream station QoS priority provides a Wi-Fi multi-media (WMM) upstream QoS prioritization. In one or more embodiments, the downstream QoS priority provides a WMM downstream station QoS prioritization.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication or access network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

We claim:

1. An access point device to provide quality of service (QoS) prioritization using deep packet inspection (DPI), the access point device comprising:
a memory; and
a processor coupled to the memory, the processor configured to execute one or more computer-readable instructions stored on the memory to cause the access point device to:
receive one or more packets from a station;
inspect the one or more packets for QoS information using DPI;
compare the QoS information to one or more DPI application categories, one or more DPI device categories, or both;
determine a QoS policy from one or more QoS policies based on the comparison; and
assign the QoS policy to traffic associated with the session.

2. The access point device of claim 1, wherein the processor is further configured to execute the one or more computer-readable instructions to further cause the access point device to:
receive any of the one or more DPI application categories, the one or more DPI device categories, one or more QoS policies, or any combination thereof from a network resource.

3. The access point device of claim 1, wherein the QoS policy is a wireless fidelity (Wi-Fi) QoS Management differentiated services code point (DSCP) policy.

4. The access point device of claim 1, wherein the assigning the QoS policy to the traffic associated with the session comprises at least one of:
send a request to the station to assign an upstream station QoS priority to upstream station traffic of a session associated with the one or more packets based on the QoS policy;
assign a downstream station QoS priority to downstream station traffic, to the station, of the session associated with the one or more packets based on the QoS policy; and
assign an upstream access point QoS priority to upstream access point traffic of the session associated with the one or more packets based on the QoS policy.

5. The access point device of claim 4, wherein the upstream station QoS priority provides a wireless fidelity multi-media (WMM) upstream station QoS prioritization.

6. The access point device of claim 4, wherein the downstream station QoS priority provides a wireless fidelity multi-media (WMM) downstream QoS prioritization.

7. The access point device of claim 1, wherein the access point device is included in an EasyMesh network, and wherein the station is an extender access point device.

8. A method by an access point device to provide quality of service (QoS) prioritization using deep packet inspection (DPI), the method comprising:
receiving one or more packets from a station;
inspecting the one or more packets for QoS information using DPI;
comparing the QoS information to one or more DPI application categories, one or more DPI device categories, or both;
determining a QoS policy from one or more QoS policies based on the comparison; and
assigning the QoS policy to traffic associated with the session.

9. The method of claim 8, further comprising:
receiving any of the one or more DPI application categories, the one or more DPI device categories, one or more QoS policies, or any combination thereof from a network resource.

10. The method of claim 8, wherein the QoS policy is a wireless fidelity (Wi-Fi) QoS Management differentiated services code point (DSCP) policy.

11. The method of claim 8, wherein the assigning the QoS policy to the traffic associated with the session comprises at least one of:
sending a request to the station to assign an upstream station QoS priority to upstream station traffic of a session associated with the one or more packets based on the QoS policy;
assigning a downstream station QoS priority to downstream station traffic, to the station, of the session associated with the one or more packets based on the QoS policy; and
assigning an upstream access point QoS priority to upstream access point traffic of the session associated with the one or more packets based on the QoS policy.

12. The method of claim 11, wherein the upstream station QoS priority to provides a wireless fidelity multi-media (WMM) upstream QoS prioritization.

13. The method of claim 11, wherein the downstream station QoS priority provides a wireless fidelity multi-media (WMM) downstream QoS prioritization.

14. The method of claim 8, wherein the access point device is included in an EasyMesh network, and wherein the station is an extender access point device.

15. A non-transitory, computer-readable medium of an access point device storing one or more computer-readable instructions provide quality of service (QoS) prioritization using deep packet inspection (DPI) that when executed by a processor, cause the access point device to perform one or more operations comprising:
receiving one or more packets from a station;
inspecting the one or more packets for QoS information using DPI;
comparing the QoS information to one or more DPI application categories, one or more DPI device categories, or both;
determining a QoS policy from one or more QoS policies based on the comparison; and
assigning the QoS policy to traffic associated with the session.

16. The non-transitory, computer-readable medium of claim 15, wherein the one or more computer-readable instructions when executed by the processor, further cause the processor to perform the one or more operations further comprising:
receiving any of the one or more DPI application categories, the one or more DPI device categories, one or more QoS policies, or any combination thereof from a network resource.

17. The non-transitory, computer-readable medium of claim 15, wherein the QoS policy is a wireless fidelity (Wi-Fi) QoS Management differentiated services code point (DSCP) policy.

18. The non-transitory, computer-readable media of claim 15, wherein the assigning the QoS policy to the traffic associated with the session comprises at least one of:
sending a request to the station to assign an upstream station QoS priority to upstream station traffic of a session associated with the one or more packets based on the QoS policy;
assigning a downstream station QoS priority to downstream station traffic, to the station, of the session associated with the one or more packets based on the QoS policy; and
assigning an upstream access point QoS priority to upstream access point traffic of the session associated with the one or more packets based on the QoS policy.

19. The non-transitory computer-readable media of claim 18, wherein at least one of:
the upstream station QoS priority to provides a wireless fidelity multi-media (WMM) upstream QoS prioritization; and
the downstream station QoS priority provides a wireless fidelity multi-media (WMM) downstream QoS prioritization.

20. The non-transitory computer-readable media of claim 15, wherein the access point device is included in an EasyMesh network, and wherein the station is an extender access point device.
